(19) United States
(12) Patent Application Publication
(10) Pub. No.: US 2021/0157520 A1
(43) Pub. Date: May 27, 2021

(54) HARDWARE MANAGEMENT GRANULARITY FOR MIXED MEDIA MEMORY SUB-SYSTEMS

(71) Applicant: Micron Technology, Inc., Boise, ID (US)

(72) Inventors: Dhawal Bavishi, San Jose, CA (US); Jeffrey L. Scott, Apex, NC (US)

(21) Appl. No.: 16/695,928

(22) Filed: Nov. 26, 2019

(51) Int. Cl. G06F 3/06; G06F 12/1081

(52) U.S. Cl. CPC G06F 3/0659; G06F 3/0613; G06F 12/1081; G06F 3/0679; G06F 3/064

(57) ABSTRACT

A direct memory access (DMA) controller in a memory system receives a DMA command for a chunk of data to be moved from a source memory device having a first maximum access granularity to a destination memory device having a second maximum access granularity, the DMA command comprising a data mask. The DMA controller reads, using the data mask, the chunk of data from the source memory device up to the first maximum access granularity and writes, using the data mask, the chunk of data to the destination memory device up to the second maximum access granularity.

### TECHNICAL FIELD

Embodiments of the disclosure relate generally to memory sub-systems, and more specifically, relate to a direct memory access (DMA) controller to add hardware management granularity for mixed media memory sub-systems.

### BACKGROUND

A memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory sub-system in accordance with some embodiments of the present disclosure.

FIG. 2 is a block diagram illustrating operation of a DMA controller with configurable granularity for mixed media memory sub-systems in accordance with some embodiments of the present disclosure.

FIG. 3 is a block diagram illustrating operation of a DMA controller using data masking in accordance with some embodiments of the present disclosure.

FIG. 4 is a flow diagram of an example method of operation of a DMA controller with configurable granularity for management of mixed media memory sub-systems in accordance with some embodiments of the present disclosure.

FIG. 5 is a flow diagram of an example method for using a data mask while processing DMA commands in mixed media memory sub-systems in accordance with some embodiments of the present disclosure.

FIGS. 6-9 are diagrams illustrating read and write operations performed by a DMA controller with configurable granularity and using a data mask for management of mixed media memory sub-systems in accordance with some embodiments of the present disclosure.

FIG. 10 is a block diagram of an example computer system in which embodiments of the present disclosure may operate.

### DETAILED DESCRIPTION

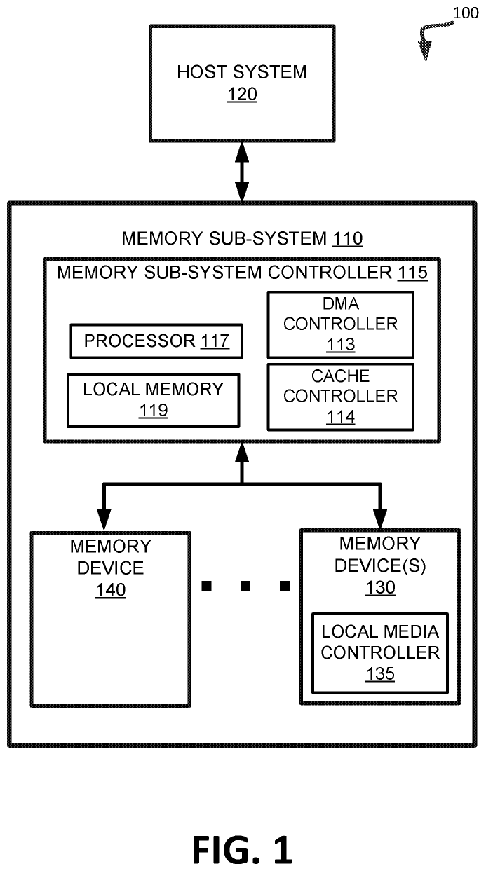

Aspects of the present disclosure are directed to a direct memory access (DMA) controller to add hardware management granularity for mixed media memory sub-systems. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

Conventional memory sub-systems generally include one or more memory devices that each use a single type of storage media. Even in a caching implementation, where one memory device (i.e., the cache) is used to store data received from the host system temporarily before being written to a second memory device (e.g., the main memory) for long term storage, both the cache and the main memory may both be implemented using the same type of media and, thus, may have the same access granularities (i.e., the size of a memory segment that can be read or written in one operation). Accordingly, a DMA controller configured to transfer data directly from the cache to the main memory while bypassing the processing device (e.g., CPU) in the memory subsystem, is configured with a fixed granularity for all data accesses.

Newer memory sub-systems, however, have seen the inclusion of mixed media types. These different types of storage media can have different access granularities. For example, an SRAM device may have an access granularity of 64 bytes, while a cross-point array of non-volatile memory devices may have an access granularity of 1 kilobyte. As such, if the DMA controller reads a certain number of 64 byte segments from the SRAM device and writes each one separately to the cross-point array of non-volatile memory devices, significant write bandwidth goes unused leading to increased overall latency in the memory sub-system.

Aspects of the disclosure address the above and other deficiencies by implementing a DMA controller with configurable granularity for management of mixed media memory sub-systems. In one embodiment, the DMA controller utilizes a data mask in connection with any access granularity up to the maximum access granularity for a given media type to coalesce read operations and/or broadcast write operations when transferring data between different types of storage media having different access granularities. The DMA controller can receive a DMA command (e.g., from the host system, from a cache controller in the memory subsystem responsible for managing the transfer of data between the cache and the main memory, etc.) indicating a data transfer. This command can include an indication of a source address, a destination address, a size of the data transfer in bytes, and an associated data mask. The data mask can include a bitwise map to segments (of a known fixed size) of a larger memory chunk or unit indicating which segments of the memory chunk or unit are to be transferred and which are not. The data mask can include a number of valid bits and a number of invalid bits, where the valid bits indicate that corresponding segments are to be transferred and the invalid bits indicate that corresponding segments are not to be transferred. Coalescing includes retaining data from a number of smaller read operations in a DMA buffer until one single larger write operation can be performed. Broadcasting includes breaking up the data from one larger read operation into a number of smaller write operations based on the access granularity of the destination media.

Using the data mask to identify which segments from a memory chunk indicated by the source address and size are to be transferred, the DMA controller can perform a number of read operations according to the access granularity of the source media type. Thus, the DMA controller can utilize segments of any size up to and including the maximum access granularity.

The DMA controller can store the data read from the source address in an internal DMA buffer(s) and, using the same data mask, initiate write transactions according to the access granularity of the destination media type. Another state machine within the DMA controller can step through each bit of the data mask, determine whether the data stored in the buffer matches the data mask (note that the data arriving in the buffer may be out of order from the way generated read requests were sent), and determine whether a number of consecutive segments to be transferred has reached the maximum access granularity of the destination address. If so, the DMA controller can perform the write transaction at the maximum access granularity of the destination media. Otherwise, the DMA controller can perform one or more write transactions of smaller size until all of the data in the buffer has been written.

Advantages of the present disclosure include, but are not limited to improved performance in the memory sub-system. Using a data mask in connection with the maximum access granularity for a given media type to coalesce and/or broadcast reads and writes offers the ability to efficiently transfer data between different types of storage media (having different access granularities) while improving system performance and reducing latency. For example, coalescing smaller write operations into a single larger write operation can be performed faster than if all of the smaller write operations were performed individually. In addition, media endurance is improved as the number of successive page accesses is reduced.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be a computing device such as a desktop computer, laptop computer, network server, mobile device, or such computing device that includes a memory and a processing device. The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the PCIe interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Although non-volatile memory components such as 3D cross-point type and NAND type flash memory are described, the memory device 130 can be based on any other type of non-volatile memory, such as read-only memory (ROM), phase change memory (PCM), magneto random access memory (MRAM), negative-or (NOR) flash memory, electrically erasable programmable read-only memory (EEPROM), and a cross-point array of non-volatile memory cells.

One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units (MUs).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical MU address, physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes a DMA controller 113 with configurable granularity for management of a mixed media memory sub-system. In one embodiment, the DMA controller 113 is integrated with memory sub-system controller 115. In another embodiment, the DMA controller 113 is a standalone hardware device, separate from memory sub-system controller 115, and operatively coupled with memory devices 130 and 140. DMA controller 113 is configured to receive a DMA command (e.g., from memory sub-system controller 115 or some other component in memory sub-system 110) for a chunk of data to be moved from a first memory device (e.g., memory device 140 or one of memory devices 130) having a first maximum access granularity to a second memory device (e.g., another one of memory devices 130) having a second maximum access granularity. In one embodiment, the DMA command is received from a cache controller 114 in the memory subsystem responsible for managing the transfer of data between the cache (e.g., memory device 14) and the main memory (e.g., memory device 130). In one embodiment, the DMA command includes, among other information, a data mask including a bitwise map of segments of the chunk of data indicating which segments are to be moved and which segments are not to be moved. DMA controller 113 can read, using the data mask, the chunk of data from the first memory device according to the first maximum access granularity (i.e., in segments of any size up to and including the first maximum access granularity) and write, using the data mask, the chunk of data to the second memory device according to the second maximum access granularity (i.e., in segments of any size up to and including the second maximum access granularity). Further details with regards to the operations of DMA controller 113 are described below.

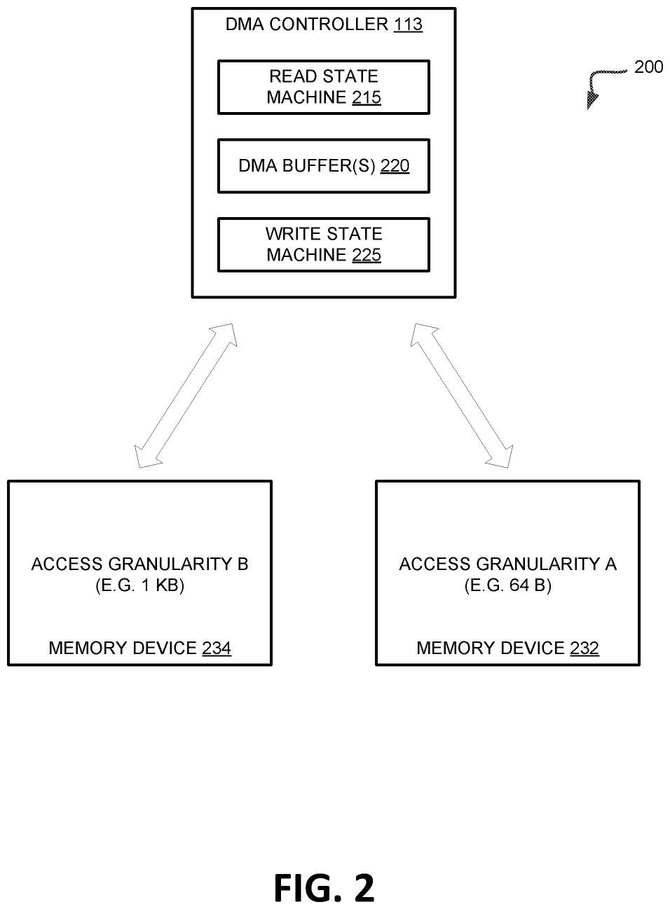

FIG. 2 is a block diagram illustrating operation 200 of a DMA controller with configurable granularity for mixed media memory sub-systems in accordance with some embodiments of the present disclosure. In one embodiment, DMA controller 113 is operatively coupled with memory device 232 and memory device 234, where memory device 232 can be used as a cache for memory device 234, which serves as a main memory (i.e., the primary data storage area where data received from the host system 120 can be stored for extended periods of time). Memory device 232 and memory device 234 can be examples of memory device 140 and/or memory devices 130, described above. Due to the performance characteristics and cost of different memory media types, memory device 232 and memory device 234 can be implemented using different media types. For example, memory device 232 (i.e., the cache memory) can be implemented using a more expensive media type but that has better performance, while memory device 234 (i.e., the main memory) can be implemented using a media type with slower performance, but that is less expensive. In one embodiment, memory devices 232 and 234 can include volatile memory devices, non-volatile memory devices, or a combination such that one of memory devices 232 is a volatile memory device while the other is a non-volatile memory device. Since memory devices 232 and 234 can be implemented using different media types, memory device 232 and memory device 234 can also have different access granularities. For example, memory device 232 may have an access granularity A (e.g., 64 bytes) and memory device 234 may have an access granularity B (e.g., 1 kilobyte). In other implementations any number different memory devices can be used, each having one of the above or a different access granularity.

During operation of the memory sub-system 100, memory sub-system controller 115 can have reason to move data from memory device 232 to memory device 234 or vice versa, such as, for a cache eviction procedure or a cache fill procedure. The DMA controller 113 can move data between memory devices that have different access granularity sizes. The DMA controller 113 can move data from a memory device having a particular access granularity size to a memory device that has a larger access granularity size. For example, as part of a cache eviction procedure, memory sub-system controller 115 can instruct DMA controller 113 to move one or more chunks of data from memory device 232 to memory device 234. In response, DMA controller 113 can read data from memory device 232 in data segments of a fixed size according to the access granularity A (e.g., 64 bytes) until the requested data has been retrieved. The DMA controller 113 can include one or more state machines to control access operations. In one embodiment, read state machine 215 (e.g., a hardware component) controls the read operation, as will be described in more detail below. DMA controller 113 can store the data segments in internal DMA buffer 220. In one embodiment, rather than writing the data segments to memory device 234 as they are received at the DMA controller 113 and according to the access granularity A (thereby wasting significant write bandwidth since memory device 234 can accept write operations up to 1 kilobyte in size), DMA controller 113 can perform data coalescing. During data coalescing, DMA controller 113 can maintain the data segments of access granularity A received from memory device 232 in DMA buffer 220, and coalesce data segments in the DMA buffer 220 up to the access granularity B of memory device 234. Using the example above, DMA controller 113 can coalesce up to 16 segments of access granularity A (e.g., 64 bytes) in DMA buffer 220 and then perform one or more write operations to memory device 234 using up to access granularity B (e.g., 1 kilobyte). In one embodiment, write state machine 225 (e.g., a hardware component) controls the write operation, as will be described in more detail below. Depending on the embodiment, memory sub-system controller 115 can configure the variable access granularities of read state machine 215 and write state machine 225 by programming a representative value(s) into a corresponding register (not shown).

The DMA controller 113 can move data from a memory device having a particular access granularity size to a memory device that has a smaller access granularity size. For example, as part of a cache fill procedure, memory sub-system controller 115 can instruct DMA controller 113 to move one or more chunks of data from memory device 234 to memory device 232. In response, DMA controller 113 can read data from memory device 234 in segments of a fixed size according to the access granularity B (e.g., 1 kilobyte) until the entire requested chunk of data has been retrieved. DMA controller 113 can store the segments in internal DMA buffers 220. In one embodiment, rather than writing the data segments to memory device 232 according to the access granularity B (which cannot be accommodated by memory device 232), DMA controller 113 can perform data broadcasting. The DMA controller 113 can divide a larger data segment into multiple smaller data segments. The smaller data segments can be the size of the access granularity corresponding to the destination memory device. The DMA controller 113 can perform multiple write operations to write data of the smaller data segments to a destination memory device. For example, during data broadcasting, DMA controller 113 can break up the data segments of access granularity B received from memory device 234 into smaller data segments of access granularity A. Using the example above, DMA controller 113 can divide one segment of access granularity B (e.g., 1 kilobyte) into approximately 16 segments of access granularity A (e.g., 64 bytes) and then perform 16 write operations to memory device 232 using access granularity A (e.g., 64 bytes).

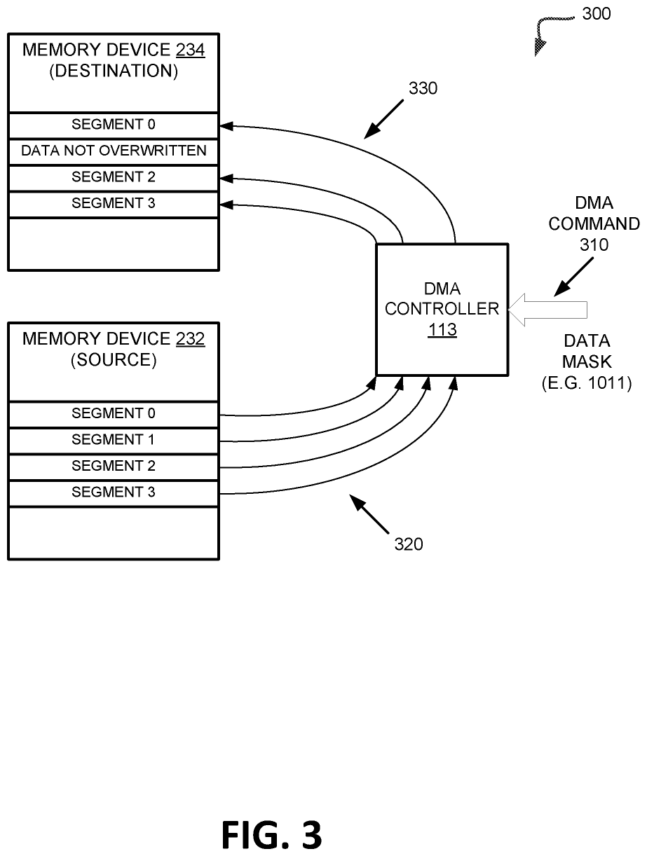

FIG. 3 is a block diagram illustrating operation 300 of a DMA controller using data masking in accordance with some embodiments of the present disclosure. In one embodiment, the DMA controller receives a DMA command 310 from at least one host system 120, memory sub-system controller 115, or from some other component in the memory sub-system 110 (e.g., a cache controller 114). The DMA command 310 is associated with a data transfer, and can include, among other information, an indication of a source address, a destination address, a size of the data to be transferred, and an associated data mask. The source address can indicate a chunk of data to be transferred (e.g., a range of memory addresses in memory device 232) and the destination address can indicate a location to which the chunk of data is to be transferred (e.g., a range of memory addresses in memory device 234). Depending on the embodiment, the source address and destination address can be physically located on either the same or different memory device(s). The size of the transfer can indicate how much data is to be transferred (e.g., expressed in bytes). The data mask can include a bitwise map to segments (of a known fixed size) of the memory chunk indicating which segments are to be transferred and which are not. In one embodiment, the DMA controller 113 utilizes the data mask in connection with the maximum access granularity for each media type of the source memory device 232 and the destination memory device 234 to coalesce and/or broadcast reads and writes when transferring data between the different types of storage media having different access granularities.

In one embodiment, the memory chunk indicated by the source address in DMA command 310 may include a series of segments from memory device 232 (e.g., segment 0, segment 1, segment 2, segment 3). The data mask can include an n-bit value where “n” corresponds to the number of segments in the memory chunk (in this case 4-bits). With each bit corresponding to one of the number of segments, the value of each bit indicates whether the corresponding segment is to be transferred or not. In one embodiment, a value of “1” indicates that the corresponding segment is to be transferred and a value of “0” indicates that the corresponding segment is not to be transferred. In other embodiments, however, the meaning of these values may be reversed. Thus, in one embodiment, DMA controller 113 can read 320 all of the segments of the memory chunk from the source address in memory device 232 and, using the data mask, selectively write 330 certain segments to the destination address in memory device 234. If, for example, the data mask has a 4-bit value of “1011,” DMA controller 113 can write segment 0, segment 2 and segment 3 to the destination address in memory device 234. Since the second bit of the data mask is “0,” however, DMA controller 113 does not write segment 1 to the destination address in memory device 234, thereby leaving the data at the destination memory location unchanged and not overwritten. In another embodiment, the DMA controller 113 selectively reads 320 only certain segments (e.g., segment 0, segment 2 and segment 3) from source memory device 232 (rather than reading all of the segments from source memory device 232) and writes 330 those segments to destination memory device 330.

In one embodiment, DMA controller 113 further coalesces or broadcasts the write 330 depending on the access granularities of the source memory device 232 and the destination memory device 234. For example, DMA controller 113 can hold data from a number of smaller read operations until one single or multiple larger write operation can be performed or can break up the data from one larger read operation into a number of smaller write operations as appropriate based on the access granularities. Using the data mask in connection with the configurable access granularities ensures that a minimal amount of bandwidth is wasted, reduces latency, reduces the number of access operations performed, reduces wear on the physical media, and improves performance in the memory sub-system.

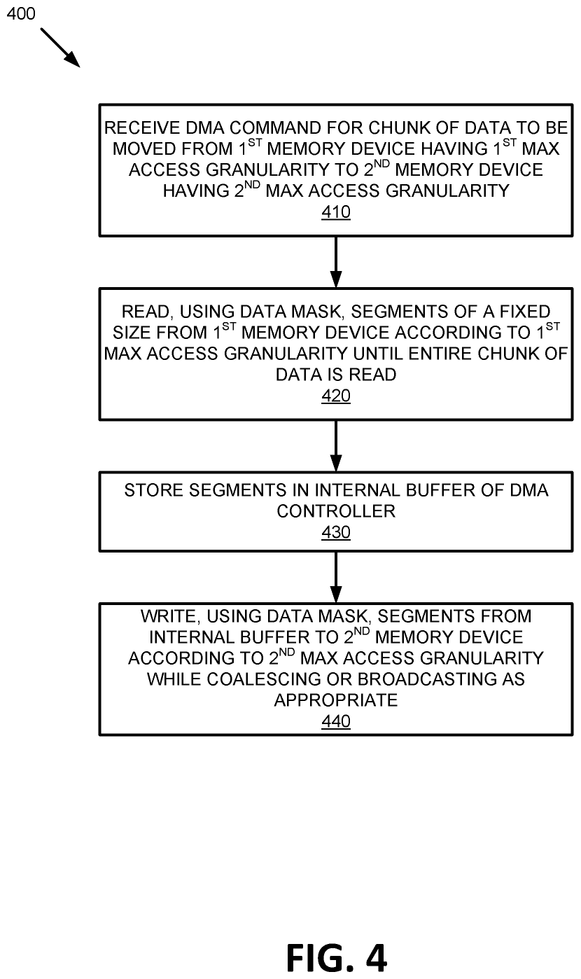

FIG. 4 is a flow diagram of an example method of operation of a DMA controller with configurable granularity for management of mixed media memory sub-systems in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof In some embodiments, the method 400 is performed by DMA controller 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives a DMA command for a chunk of data to be moved from a source memory device 232 having a source access granularity to a second memory device 234 having a second maximum access granularity. The DMA command 310 can include, among other information, an indication of a source address, a destination address, a size of the transfer, and an associated data mask. The data mask can include a bitwise map of segments of the chunk of data indicating which segments are to be moved and which segments are not to be moved. In one embodiment, the DMA command can be received as part of a cache eviction procedure, whereby DMA controller 113 can move the chunk of data from memory device 232. In another embodiment, the DMA command can be received as part of a cache fill procedure, whereby DMA controller 113 can move the chunk of data from memory device 234 serving as a main memory to memory device 232 serving as a cache memory. Since memory device 232 and memory device 234 can be implemented using different media types, memory device 232 and memory device 234 can also have different maximum access granularities. The maximum access granularity of each media type can indicate the maximum size of a memory segment that can be read or written in one operation.

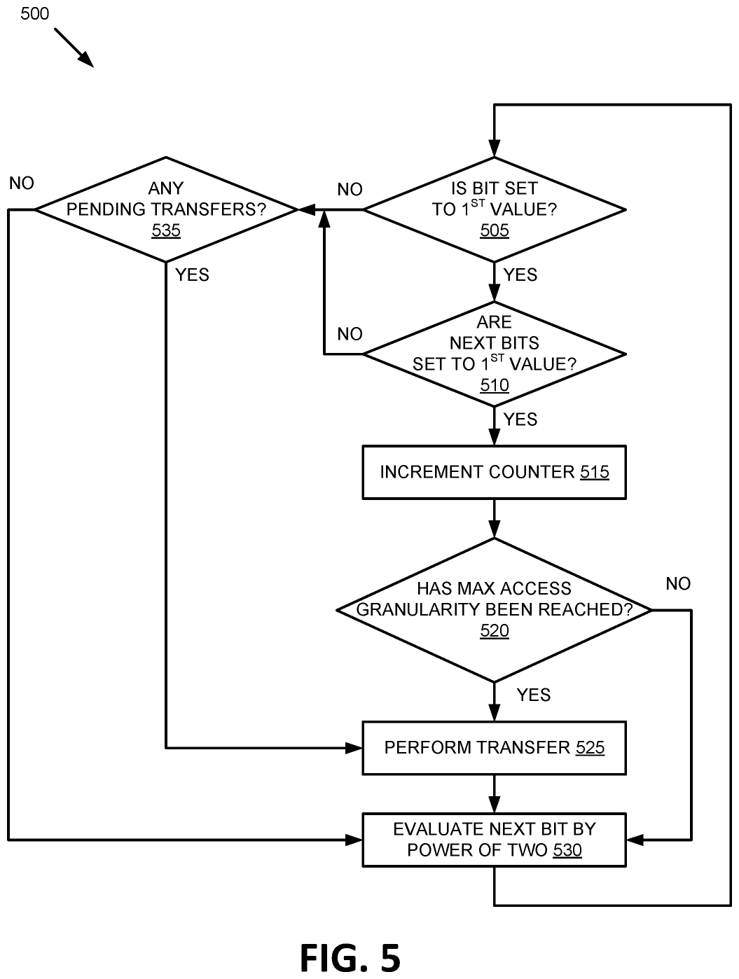

At operation 420, the processing logic reads, using the data mask, the chunk of data from the first memory device 232 according to the first maximum access granularity. In one embodiment, DMA controller 113 can read multiple segments of a fixed size from the first memory device 232 until the entire chunk of data is read. Using the data mask, DMA controller 113 can identify certain segments from the chunk of data that are to be transferred and read only those segments from the first memory device 232. Other segments from the chunk of data not identified by the data mask can be left in their original location on the first memory device 232. Additional details pertaining to using the data mask are described below with respect to FIGS. 5-9. At operation 430, the processing logic stores the plurality of segments in an internal buffer 220 of the DMA controller 113.

At operation 440, the processing logic writes, using the data mask, the chunk of data to the second memory device 234 according to the second maximum access granularity. In one embodiment, DMA controller 113 can read the plurality of segments from the internal buffer 220 and write the plurality of segments to the second memory device 234. Depending on the difference between the first maximum access granularity and the second maximum access granularity, DMA controller 113 can coalesce or broadcast the write operations, as appropriate. When the first maximum access granularity is less than the second maximum access granularity, DMA controller 113 can coalesce a subset of the plurality of segments into a single write operation according to the second maximum access granularity. When the second maximum access granularity is less than the first maximum access granularity, DMA controller 113 can broadcast a subset of the plurality of segments into a plurality of write operations according to the first maximum access granularity.

FIG. 5 is a flow diagram of an example method for using a data mask while processing DMA commands in mixed media memory sub-systems in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by DMA controller 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing logic determines whether a certain bit of a data mask is set to a move value indicating that a corresponding segment is to be moved (e.g., copied, transfer) from a source memory device 232 to a destination memory device 234. In one embodiment, when the data mask includes a bitwise map of memory segments, the move value indicating a data move is a logical “1” and a logical “0” indicates that the corresponding data at the segment is not to be moved. In other embodiments, the meanings of the values may be reversed.

If the certain bit of the data mask is set to the move value, at operation 510, the processing logic determines whether of the bits the next bit(s) being evaluated are set to the first value. In one embodiment, DMA controller 113 performs a logical AND operation of all of the bits being evaluated to determine whether they are all set to the first value.

If all of the bits being evaluated are set to the first value, at operation 515, the processing logic increments a counter (e.g., stored within DMA controller 113 or in local memory 119). In one embodiment, a value of the counter is indicative of how many segments of a known fixed size are ready to be either read or written. DMA controller 113 is aware of the known fixed size (e.g., 64 bytes) and thus, using the number of segments, can determine the total size of the data transfer to be performed. For example, if the value of the counter is four (4), DMA controller 113 can determine that the total size of the data transfer is 256 bytes.

At operation 520, the processing logic determines whether the maximum access granularity has been reached. In one embodiment, DMA controller 113 compares the total size of the data transfer to the maximum access granularity for the memory device from which data is being read or to which data is being written. If the total size of the data transfer is equal to the maximum access granularity, DMA controller 113 determines that the maximum access granularity has been reached.

If the maximum access granularity has been reached, at operation 525, the processing logic issues a command to perform the data transfer. In one embodiment, DMA controller 113 either reads or writes the segments indicated by the bits of the data mask to/from one of memory device 232 or memory device 234.

If the maximum access granularity has not been reached, or after the command is issued at operation 525, at operation 530, the processing logic evaluates the next bit in the data mask by a power of two and returns to operation 505. In one embodiment, DMA controller 113 uses an output of one of read state machine 215 or write state machine 225 to determine which bit in the data mask to examine. Each of read state machine 215 and write state machine 225 can cycle through various states, where each subsequent state increments by a power of two. For example, when starting with the most significant bit of the data mask, during a first iteration, DMA controller 113 examines the second most significant bit (i.e., 2¹), during a second iteration, DMA controller 113 examines the fourth most significant bit (i.e., 2²), during a third iteration DMA controller 113 examines the eighth most significant bit (i.e., 2³), and so on. At operation 505, DMA controller 113 determines whether the bit being examined is set to the move value. The intermediate values are not individually examined, but are treated as bits being evaluated at operation 510. Thus, if DMA controller 113 determines, at operation 505, whether the most significant bit is set to the first value, whether the second most significant bit is set to the first value, and whether the fourth most significant bit is set to the first value, at operation 510, DMA controller 113 also determines whether the intervening third most significant bit is set to the first value by performing a logical AND operation of the first most significant bit, the second most significant bit, the third most significant bit, and the fourth most significant bit.

Once DMA controller 113 identifies at least one bit of the bits being evaluated that is not set to the first value (i.e., is set to the second value indicating that the corresponding segment is not to be transferred) either at operation 505 or operation 510, at operation 535, the processing logic determines whether there are any segments ready to be transferred (i.e., pending transfers). Depending on the embodiment, DMA controller 113 either reads internal buffer 220 to check for segments or reads the value of the counter. If there are pending transfers, those segments are transferred at operation 525. If there are no pending transfers, read state machine 215 and write state machine 225 are reset to an initial state and the processing logic evaluates the next bit to be examined at operation 530.

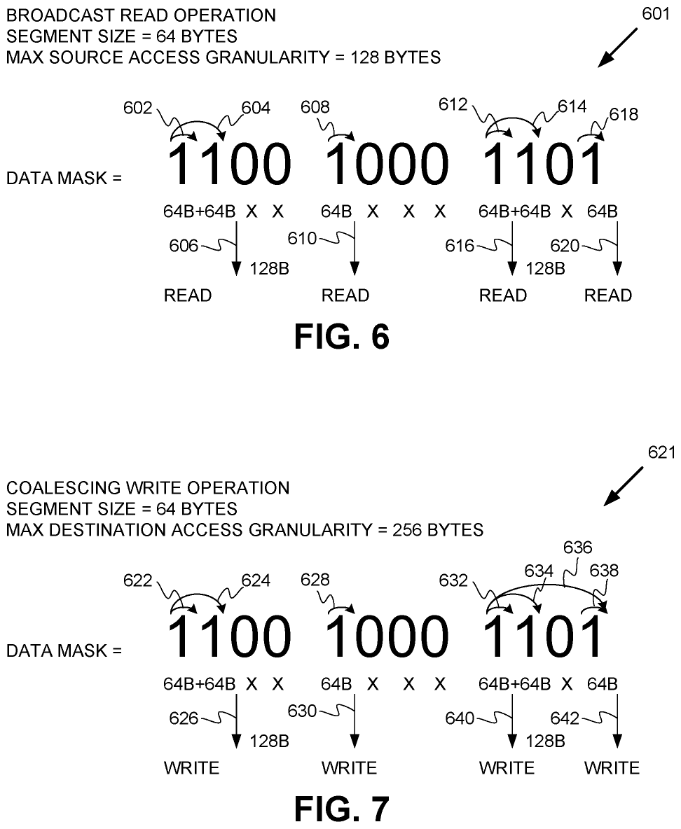

FIGS. 6-9 are diagrams illustrating read and write operations performed by a DMA controller with configurable granularity and using a data mask for management of mixed media memory sub-systems in accordance with some embodiments of the present disclosure. FIG. 6 illustrates an example of a broadcast transfer operation 601 to transfer data from a source memory device having an access granularity size larger than an access granularity size of a destination memory device. For example, the maximum access granularity of the source memory device is 128 bytes. For example, the maximum access granularity of the destination memory device is 64 bytes. The maximum access granularity may be predetermined by the media types of the source and destination addresses, respectively. The broadcast transfer operation moves the data to the destination memory device using multiple write operations of smaller access granularity.

In this example, the data mask is a 12-bit data mask. The data mask is 1100 1000 1101. The number of bits in the data mask corresponds to the chunk of data indicated in a DMA command, for example, received from a host. In this example, each bit in the data mask represents a segment size of 64 bytes. In one embodiment, DMA controller 113 can perform the broadcast read operation using the data mask according to the operations of method 400 and method 500.

DMA controller 113 determines at 602 that the most significant bit of the data mask is set to a logical “1” indicating that a corresponding memory segment is to be read from the source memory device and moved to the destination memory device. Given that the size of this segment is 64 bytes, which is less than the maximum source access granularity of 128 bytes, DMA controller 113 increments the counter and evaluates the next bit by a power of two according to the output of read state machine 215. DMA controller 113 determines at 604 that the next bit is also set to a logical “1” and that the total size of both segments has reached the maximum source access granularity of 128 bytes. Accordingly, DMA controller 113 can perform a read operation 606 of both segments from the source memory device. The data read from the source memory device can be stored in DMA buffer 220 and eventually written to the destination memory device.

Since the next two bits of the data mask are set to a logical “0,” and there are no segments pending transfer, DMA controller 113 need not evaluate those bits and can identify the next bit set to a logical “1.” DMA controller 113 determines at 608 that the next bit of the data mask is set to a logical “1,” increments the counter, and evaluates the next bit. Since the next bit is set to a logical “0,” DMA controller can perform a read operation 610 of the one pending segment. This read operation is only 64 bytes which is less than the maximum source access granularity of the source memory device. The data read from the source memory device can be stored in DMA buffer 220 and eventually written to the destination memory device.

DMA controller 113 can identify at 612 the next bit of the data mask set to a logical “1”, increment the counter, and evaluates the next bit by a power of two (i.e., two bits). DMA controller 113 can determine at 614 that the next bit is also set to a logical “1” and that the total size of both segments has reached the maximum source access granularity of 128 bytes. Accordingly, DMA controller 113 can perform a read operation 616 of both segments from the source memory device. The data read from the source memory device can be stored in DMA buffer 220 and eventually written to the destination memory device.

DMA controller 113 can identify at 618 the next bit of the data mask set to a logical “1” and determine that the boundary (i.e., end) of the data mask has been reached. DMA controller can perform a read operation 620 of the one memory segment. The data read from the source memory device can be stored in DMA buffer 220 and eventually written to the destination memory device.

FIG. 7 illustrates a second example 621 of a coalescing transfer operation, where the fixed segment size is 64 bytes, the maximum access granularity of the destination memory device is 256 bytes, and the 12-bit data mask is 1100 1000 1101. In one embodiment, DMA controller 113 can perform the coalescing write operation using the data mask according to the operations of method 400 and method 500.

DMA controller 113 determines at 622 that the most significant bit of the data mask is set to a logical “1” indicating that a corresponding memory segment read from the source memory device and stored in the internal buffer 220 is to be written to the destination memory device. Knowing that the size of this segment is 64 bytes, which is less than the maximum destination access granularity of 256 bytes, DMA controller 113 evaluates the next bit by a power of two according to the output of write state machine 225. DMA controller 113 determines at 624 that the next bit is also set to a logical “1” and that the total size of both segments is still less than the maximum destination access granularity. Since the next two bits are set to a logical “0,” however, DMA controller 113 can determine the value the of the remaining skipped bits by performing a logical AND operation of all the bits together within a power of 2 bit set. If the result is a 0, the DMA controller can drop the power by 1 and can perform a write operation 626 of both segments having a corresponding bit set to a logical “1” to the destination memory device. DMA controller 113 determines at 628 that the next bit of the data mask is set to a logical “1,” increments the counter, and evaluates the next bit. Since the next bit is set to a logical “0,” DMA controller can perform a write operation 610 of the one pending segment. Since the next two bits of the data mask are set to a logical “0,” and there are no segments pending transfer, DMA controller 113 can skip those bits and identify the next bit set to a logical “1.” DMA controller 113 can identify at 632 the next bit of the data mask set to a logical “1” and evaluate the next bit by a power of two (i.e., two bits). DMA controller 113 can determine at 634 that the next bit is also set to a logical “1” and that the total size of both segments is still less than the maximum destination access granularity of 256 bytes. DMA controller 113 can evaluate the next bit by a power of two (i.e., four bits), determine at 636 that the least significant bit is a logical “1,” perform a logical AND operation of all of the bits being evaluated (including the skipped bit), and determine that the logical AND operation results in a “0.” This result indicates that the skipped bit was set to a logical “0.” Accordingly, DMA controller 113 can perform a write operation 640 of two segments to the destination memory device and a write operation 642 of one segment to the destination memory device.

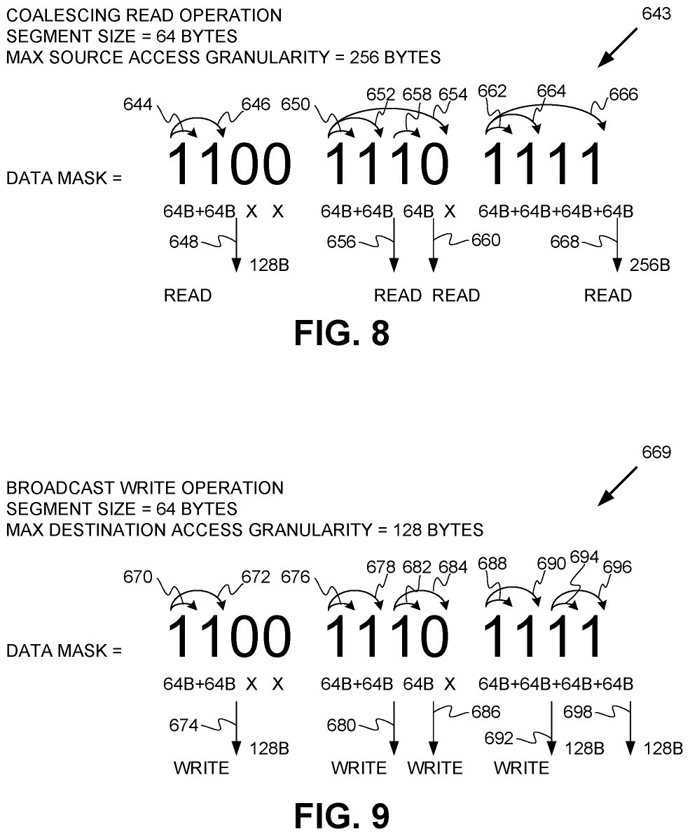

FIG. 8 illustrates a third example 643 of a coalescing read operation, where the fixed segment size is 64 bytes, the maximum access granularity of the source memory device is 256 bytes, and the 12-bit data mask is 1100 1110 1111. In one embodiment, DMA controller 113 can perform the coalescing read operation using the data mask according to the operations of method 400 and method 500. DMA controller 113 determines at 644 that the most significant bit of the data mask is set to a logical “1” indicating that a corresponding memory segment is to be read from the source memory device. Knowing that the size of this segment is 64 bytes, which is less than the maximum source access granularity of 256 bytes, DMA controller 113 evaluates the next bit by a power of two according to the output of read state machine 215. DMA controller 113 determines at 646 that the next bit is also set to a logical “1” and that the total size of both segments is still less than the maximum source access granularity of 256 bytes. Since the next two bits are set to a logical “0,” however, DMA controller 113 can perform a read operation 648 of both segments from the source memory device.

Since the next two bits of the data mask are set to a logical “0,” and there are no segments pending transfer, DMA controller 113 can skip those bits and identify the next bit set to a logical “1.” DMA controller 113 determines at 650 that the next bit of the data mask is set to a logical “1,” increments the counter, and evaluates the next bit. DMA controller 113 determines at 652 that the next bit is also set to a logical “1” and that the total size of both segments is still less than the maximum source access granularity of 256 bytes. DMA controller 113 can evaluate the next bit by a power of two (i.e., four bits), determine at 654 that the bit is set to a logical “0,” and then perform a read operation 656 of the two pending segments from the source memory device. DMA controller 113 goes back to examine the skipped bit and determines at 658 that the skipped bit is set to a logical “1.” Accordingly, DMA engine 113 can perform a read operation 660 of one segment from the source memory device.

DMA controller 113 determines at 662 that the next bit of the data mask is set to a logical “1,” increments the counter, and evaluates the next bit. DMA controller 113 determines at 664 that the next bit is also set to a logical “1” and that the total size of both segments is still less than the maximum source access granularity of 256 bytes. DMA controller 113 can evaluate the next bit by a power of two (i.e., four bits), determine at 666 that the bit is set to a logical “1,” perform a logical AND operation of all of the bits being evaluated (including the skipped bit), and determine that the logical AND operation results in a “1.” This result indicates that the skipped bit was set to a logical “1.” Accordingly, DMA controller 113 can perform a read operation 668 of all four segments from the source memory device.

FIG. 9 illustrates a fourth example 669 of a broadcast write operation, where the fixed segment size is 64 bytes, the maximum access granularity of the destination memory device is 128 bytes, and the 12-bit data mask is 1100 1110 1111. In one embodiment, DMA controller 113 can perform the broadcast write operation using the data mask according to the operations of method 400 and method 500. DMA controller 113 determines at 670 that the most significant bit of the data mask is set to a logical “1” indicating that a corresponding memory segment in the internal buffer 220 of the DMA controller 113 is to be written to the destination memory device. Knowing that the size of this segment is 64 bytes, which is less than the maximum destination access granularity of 128 bytes, DMA controller 113 evaluates the next bit by a power of two according to the output of write state machine 225. DMA controller 113 determines at 672 that the next bit is also set to a logical “1” and that the total size of both segments is equal to the maximum destination access granularity of 128 bytes. Accordingly, DMA controller 113 can perform a write operation 674 of both segments to the destination memory device.

Since the next two bits of the data mask are set to a logical “0,” and there are no segments pending transfer, DMA controller 113 can skip those bits and identify the next bit set to a logical “1.” DMA controller 113 determines at 676 that the next bit of the data mask is set to a logical “1,” increments the counter, and evaluates the next bit. DMA controller 113 determines at 678 that the next bit is also set to a logical “1” and that the total size of both segments is equal to the maximum destination access granularity. Accordingly, DMA controller 113 can perform a write operation 680 of both segments to the destination memory device. DMA controller 113 determines at 682 that the next bit of the data mask is set to a logical “1,” increments the counter, and evaluates the next bit. DMA controller 113 determines at 684 that the next bit is set to a logical “0.” Accordingly, DMA controller 113 can perform a write operation 686 of the one pending segment to the destination memory device.

DMA controller 113 determines at 688 that the next bit of the data mask is set to a logical “1,” increments the counter, and evaluates the next bit. DMA controller 113 determines at 690 that the next bit is also set to a logical “1” and that the total size of both segments is equal to the maximum destination access granularity of 128 bytes. Accordingly, DMA controller 113 can perform a write operation 692 of both segments to the destination memory device. DMA controller 113 determines at 694 that the next bit of the data mask is set to a logical “1,” increments the counter, and evaluates the next bit. DMA controller 113 determines at 696 that the next bit is also set to a logical “1” and that the total size of both segments is equal to the maximum destination access granularity of 128 bytes. Accordingly, DMA controller 113 can perform a write operation 698 of both segments to the destination memory device.

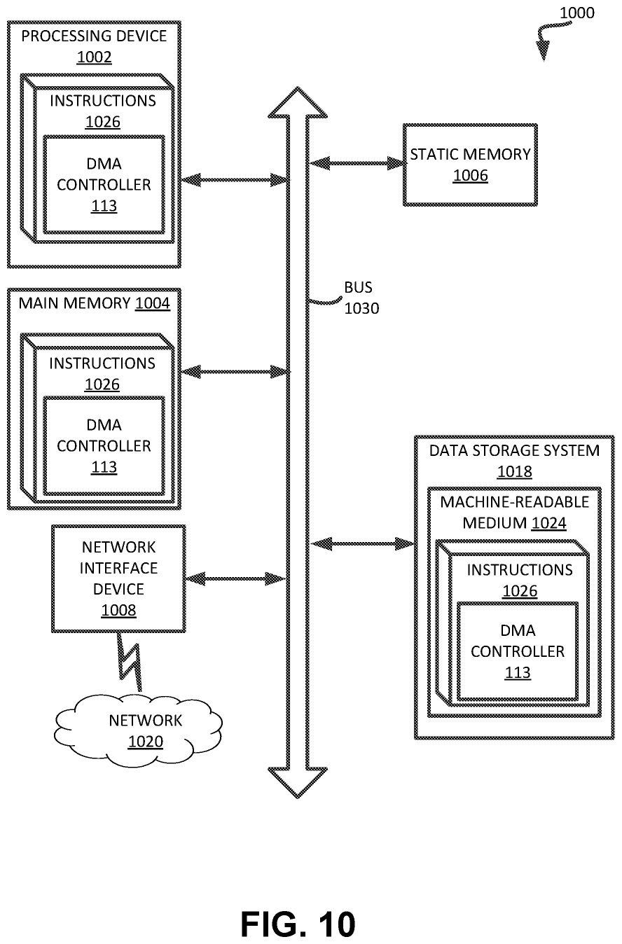

FIG. 10 illustrates an example machine of a computer system 1000 within which a set of instructions, for causing the machine to perform any one or more of the methodologies discussed herein, can be executed. In some embodiments, the computer system 1000 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to DMA controller 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage system 1018, which communicate with each other via a bus 1030.

Processing device 1002 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein. The computer system 1000 can further include a network interface device 1008 to communicate over the network 1020.

The data storage system 1018 can include a machine-readable storage medium 1024 (also known as a computer-readable medium) on which is stored one or more sets of instructions 1026 or software embodying any one or more of the methodologies or functions described herein. The instructions 1026 can also reside, completely or at least partially, within the main memory 1004 and/or within the processing device 1002 during execution thereof by the computer system 1000, the main memory 1004 and the processing device 1002 also constituting machine-readable storage media. The machine-readable storage medium 1024, data storage system 1018, and/or main memory 1004 can correspond to the memory sub-system 110 of FIG. 1.

In one embodiment, the instructions 1026 include instructions to implement functionality corresponding to DMA controller 113 of FIG. 1. While the machine-readable storage medium 1024 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of memory devices comprising a source memory device having a source maximum access granularity and a destination memory device having a destination maximum access granularity;
a processing device, operatively coupled with the plurality of memory devices; and
a direct memory access (DMA) controller, operatively coupled with the plurality of memory devices, to perform operations comprising:
receiving a DMA command for a chunk of data to be moved from the source memory device to the destination memory device, the DMA command comprising a data mask;
reading, using the data mask, the chunk of data from the source memory device up to the first maximum access granularity; and
writing, using the data mask, the chunk of data to the destination memory device up to the second maximum access granularity.

2. The system of claim 1, wherein the DMA controller is separate from the processing device, the DMA controller to move the chunk of data from the source memory device to the destination memory device while bypassing the processing device.

3. The system of claim 1, wherein the data mask comprises a bitwise map of segments of the chunk of data, the bitwise map indicating which segments are to be moved and which segments are not to be moved.

4. The system of claim 1, wherein reading the chunk of data from the source memory device comprises:
reading a plurality of segments of a fixed size from the source memory device until the entire chunk of data is read; and
storing the plurality of segments in an internal buffer of the DMA controller.

5. The system of claim 4, wherein writing the chunk of data to the destination memory device comprises:
reading the plurality of segments from the internal buffer; and
writing the plurality of segments to the destination memory device.

6. The system of claim 1, wherein when the first maximum access granularity is less than the second maximum access granularity, the DMA controller to coalesce a subset of the plurality of segments into a single write operation up to the second maximum access granularity.

7. The system of claim 1, wherein when the second maximum access granularity is less than the first maximum access granularity, the DMA controller to broadcast a subset of the plurality of segments into a plurality of write operations up to the first maximum access granularity.

8. A method comprising:
receiving, by a direct memory access (DMA) controller, a DMA command for a chunk of data to be moved from a source memory device having a first maximum access granularity to a destination memory device having a second maximum access granularity, the DMA command comprising a data mask;
reading, by the DMA controller and using the data mask, the chunk of data from the source memory device up to the first maximum access granularity; and
writing, by the DMA controller and using the data mask, the chunk of data to the destination memory device up to the second maximum access granularity.

9. The method of claim 8, wherein the data mask comprises a bitwise map of segments of the chunk of data, the bitwise map indicating which segments are to be moved and which segments are not to be moved

10. The method of claim 8, wherein reading the chunk of data from the source memory device comprises:
reading a plurality of segments of a fixed size from the source memory device until the entire chunk of data is read; and
storing the plurality of segments in an internal buffer of the DMA controller.

11. The method of claim 10, wherein writing the chunk of data to the destination memory device comprises:
reading the plurality of segments from the internal buffer; and
writing the plurality of segments to the destination memory device.

12. The method of claim 8, wherein when the first maximum access granularity is less than the second maximum access granularity, the method further comprises:
coalescing, by the DMA controller, a subset of the plurality of segments into a single write operation up to the second maximum access granularity.

13. The method of claim 8, wherein when the second maximum access granularity is less than the first maximum access granularity, the method further comprises:
broadcasting, by the DMA controller, a subset of the plurality of segments into a plurality of write operations up to the first maximum access granularity.

14. A system comprising:
a plurality of memory devices comprising a source memory device having a first maximum access granularity and a destination memory device having a second maximum access granularity;
a processing device, operatively coupled with the plurality of memory devices; and
a direct memory access (DMA) controller, operatively coupled with the plurality of memory devices, to perform operations comprising:
determining that a data mask indicates that a first segment of a chunk of data is to be transferred from the source memory device to the destination memory device;
incrementing a counter tracking a number of consecutive segments to be transferred;
determining whether a value of the counter indicates that the number of segments has reached the first maximum access granularity;
responsive to the number of segments reaching the first maximum access granularity, performing a read operation on the number of segments from the source memory device; and
writing the number of segments to the destination memory device up to the second maximum access granularity.

15. The system of claim 14, wherein the DMA controller is separate from the processing device, the DMA controller to move the chunk of data from the source memory device to the destination memory device while bypassing the processing device.

16. The system of claim 14, wherein the data mask comprises a bitwise map of segments of the chunk of data, the bitwise map indicating which segments are to be moved and which segments are not to be moved.

17. The system of claim 14, wherein the DMA controller to perform further operations comprising:
selecting a second segment of the chunk of data according to the output of a state machine; and
determining whether the data mask indicates that the second segment is to be transferred from the source memory device to the destination memory device.

18. The system of claim 14, wherein the DMA controller to perform further operations comprising:
storing the number of segments in an internal buffer of the DMA controller.

19. The system of claim 18, wherein when the first maximum access granularity is less than the second maximum access granularity, the DMA controller to coalesce the number of segments in the internal buffer until a combined size of the segments in the internal buffer reaches the second maximum access granularity.

20. The system of claim 17, wherein when the second maximum access granularity is less than the first maximum access granularity, the DMA controller to divide the number of segments in the internal buffer into a plurality of subsets, each of the plurality of subsets having a size less than or equal to the first maximum access granularity and to broadcast the plurality of subsets to the destination memory device separately.
